(19) United States
(12) Patent Application Publication
(10) Pub. No.: US 2013/0038843 A1
(43) Pub. Date: Feb. 14, 2013

(54) HIGH PRESSURE DISCHARGE LAMP BALLAST AND A METHOD FOR DRIVING A HIGH PRESSURE DISCHARGE LAMP BALLAST

(71) Applicants: Yuya YAMAZAKI, Gyoda-shi (JP); Tooru NAGASE, Gyoda-shi (JP); Shinichi SUZUKI, Gyoda-shi (JP); Yoshiaki KOMATSU, Gyoda-shi (JP)

(72) Inventors: Yuya YAMAZAKI, Gyoda-shi (JP); Tooru NAGASE, Gyoda-shi (JP); Shinichi SUZUKI, Gyoda-shi (JP); Yoshiaki KOMATSU, Gyoda-shi (JP)

(73) Assignee: IWASAKI ELECTRIC CO., LTD., Tokyo (JP)

(21) Appl. No.: 13/207,834

(22) Filed: Aug. 11, 2011

(51) Int. Cl. G03B 21/20; H05B 41/36

(52) U.S. Cl. 353/85; 315/224

(57) ABSTRACT

The high pressure discharge lamp ballast of the present invention includes: power supply means for supplying an AC current to a lamp; and control means for cyclically changing a current value of the AC current to be supplied and a time interval between polarity inversions. The AC current has a cycle of a time period TL and a time period TS, and the power supply means is controlled by the control means to apply a half cycle of a first low frequency current and, immediately after that, apply one cycle of a high frequency current in the time period TL, the high frequency current in only the second half of the cycle or the entire cycle having a peak current value that is higher than a current value of the first low frequency current, and to repeat cycles of only a second low frequency current in the time period

### FIELD OF THE INVENTION

The present invention relates to a high pressure discharge lamp ballast for driving a high pressure discharge lamp, in particular, a technique for extending the life duration of the high pressure discharge lamp.

### DESCRIPTION OF THE RELATED ART

With the recent advancement in size and weight reduction of high pressure discharge lamp ballasts accompanied by their digitalization, there have been increasingly spreading out high pressure discharge lamp ballasts configured to start up a high pressure discharge lamp (hereinafter, referred to as “lamp”) 50, as shown in FIG. 4, with a rectangular wave current supplied by a combination of a step-down chopper circuit 20, a full-bridge circuit 30 and an igniter circuit 40, as shown in FIG. 1, and then keep the lamp 50 stably discharging with any selected-wave current.

Description is provided for operations of the circuits in FIG. 1. For controlling a PWM control circuit 28 included in the step-down chopper circuit 20, a resistor 26 detects a lamp voltage signal proportional to a lamp voltage, and a resistor 27 detects a lamp current signal proportional to a lamp current. A voltage signal is obtained through the multiplication of the lamp current signal by the lamp voltage signal by a multiplier, or is obtained through an operation by a microcomputer. An error amplifier compares the voltage signal with a reference voltage that is set beforehand to such a voltage that the lamp 50 can be lit with a rated lamp wattage at a rated lamp voltage. The duty cycle of a transistor 21 is adjusted under pulse-width control to keep constant the voltage signal obtained through the multiplication of the lamp current signal by the lamp voltage signal, or obtained through the operation by the microcomputer. In this way, the lamp 50 is driven with desired power.

Next, description is provided for an operation of the full-bridge circuit 30 that operates by receiving DC output from the step-down chopper circuit 20. A pair of transistors 31 and 34 and a pair of transistors 32 and 33 are alternately switched by a bridge control circuit 37, and thereby output to the lamp 50 a lamp current in which a half cycle of a low-frequency rectangular wave current and one cycle of a high-frequency rectangular wave current are applied successively in this order as shown in FIG. 2.

The PWM control circuit 28 and the bridge control circuit 37 are operated in conjunction with each other by control means 15. In summary, power supply means is formed by the step-down chopper circuit 20 and the full-bridge circuit 30, and is controlled by the control means 15. For the AC lamp current, the current value thereof is controlled by the PWM control circuit 28 and the time interval between polarity inversions thereof is controlled by the bridge control circuit 37.

The igniter circuit 40 generates high pressure pulses and applies the pulses to the lamp 50 to start up the lamp 50. After the lamp 50 starts discharging, the igniter circuit 40 stops operating.

For driving a high pressure discharge lamp, the following two points should be considered in terms of the waveform of an inputted lamp current.

The first point is flicker prevention. The flicker mentioned here is a phenomenon in which the high pressure discharge lamp outputs flickering light because the discharge spots of the arc move from one point to another on the electrodes during the driving of the lamp. The process of a phenomenon in which an electrode glows in a projection-like shape is not entirely clear but can be inferred as follows. Heated tungsten is evaporated and thereby is bonded to halogen and the like existing in the arc tube, thereby forming a tungsten compound. This tungsten compound is dissipated from around the tube wall to the vicinities of the tip ends of the electrodes, and is reduced into tungsten atoms at high temperature places. Then, the tungsten atoms are ionized to become cations in the arc. The two electrodes during AC driving serve as the anode and the cathode alternately and repeatedly at a driving frequency. When the two electrodes operate as the cathode, the cations in the arc are attracted to the cathode by the electric field and thereby the tungsten is deposited on the tip ends of the two electrodes. Thus, the deposited tungsten is considered to form the projection.

In connection with this problem, it has been known that the flicker can be properly prevented by use of a lamp current waveform as shown in FIG. 2. Specifically, a projection in an appropriate size is formed on the tip end of each electrode by taking advantage of an effect of the high frequency current in the second half cycle, and the discharge spots of the arc are fixed to the projections (for example, Patent Document 1, Japanese Patent No. 3844046).

Here, in FIG. 2, the peak current value in the second half cycle of the high frequency period is 1.1 to 1.5 times higher than the current value in the low frequency period, and a ratio of the duration of one cycle of the high frequency period to the duration of half cycle of the low frequency period is 1:4 to 1:20. In addition, the cyclic frequency of unit cycles is approximately 50 Hz to 1 kHz where a unit cycle is defined as (a half cycle of low frequency wave (positive)+one cycle of high frequency wave+a half cycle of low frequency wave (negative)+one cycle of high frequency wave).

The second point is to maintain an appropriate lamp voltage. When the lamp voltage is too low, the desired lamp power cannot be inputted even with an input of the maximum rated lamp current, and consequently the illumination intensity is lowered. In contrast, when the lamp voltage is too high, a protection operation is activated in general to stop the power supply to the lamp. A state where the protection operation is activated means that the lamp reaches the end of its life. In other words, the maintenance of an appropriate lamp voltage results in an extension of the life duration of the lamp.

Here, the maintenance of an appropriate lamp voltage is to maintain a distance between the electrodes within an appropriate range by properly controlling the growth of the projections formed on the electrodes. The projections need to be present for flicker prevention, but should not be longer than necessary to fix the arc spots thereto. When the sufficient lamp power cannot be inputted due to a low lamp voltage, however, the projections easily grow more than necessary, which is a problem. To address this problem, for example, Patent Document 2, Japanese Patent Application Publication No. 2008-41588, discloses a general high pressure discharge lamp ballast to drive with a rectangular wave current, in which, during a predetermined time period after the start of the lamp driving, a larger amount of lamp current is inputted to suppress the growth of the projections if the detected lamp voltage is lower than 60 V (if the projections grow too long). In this way, the distance between the electrodes is prevented from decreasing any more.

It is true that use of the lamp current waveform as shown in FIG. 2 brings about the formation of projections on the tip ends of the electrodes and thereby enables the flicker prevention. But, these projections are thin and small as shown by reference numerals 90 and 91 in FIG. 5A, and therefore are worn heavily. In addition, when a new projection grows after a former projection is melted, the growth start point of the new projection is not always the same as that of the former projection, and consequently the projection may move. This movement of the projection causes a movement of the arc, which in turn causes a displacement of the optical axis from the optimum position when the lamp is installed in a projector or the like, and consequently lowers the illumination intensity.

Moreover, when the control as disclosed in Patent Document 2 is performed by using the lamp current waveform as shown in FIG. 2, the projections are sometimes melted excessively because of their small size, which induces a movement of the projection.

### SUMMARY OF THE INVENTION

To address the above objectives, it is necessary to form thick projections, which are difficult to wear, on the electrodes in order to prevent flicker and a movement of the arc, and also to maintain the appropriate lamp voltage.

A first aspect of the present invention is a high pressure discharge lamp ballast including: power supply means for supplying an AC current to a high pressure discharge lamp; and control means for cyclically changing a current value of the AC current to be supplied by the power supply means and a time interval between polarity inversions. The AC current has a cycle of a time period TL and a time period TS, and the power supply means is controlled by the control means to apply a half cycle of a rectangular wave current at a first frequency (hereinafter, referred to as “first low frequency current”) and, immediately after that, apply one cycle of a current at a higher frequency than the first frequency (hereinafter, referred to as “high frequency current”) in the time period TL, the high frequency current in only the second half of the cycle or the entire cycle having a peak current value that is higher than a current value of the first low frequency current, and to repeat cycles of only a rectangular wave current at a second frequency (hereinafter, referred to as “second low frequency current”) in the time period TS.

A second aspect of the present invention is a projector including the high pressure discharge lamp ballast of the first aspect of the present invention, a high pressure discharge lamp, a reflector to which the high pressure discharge lamp is attached, and a casing in which the high pressure discharge lamp ballast and the reflector are housed.

A third aspect of the present invention is a method for driving a high pressure discharge lamp by using power supply means for supplying an AC current to a high pressure discharge lamp; and control means for cyclically changing a current value of the AC current to be supplied by the power supply means and a time interval between polarity inversions. The method includes: a step (TL) of applying a half cycle of a rectangular wave current at a first frequency (hereinafter, referred to as “first low frequency current”) and, immediately after that, applying one cycle of a current at a higher frequency than the first frequency (hereinafter, referred to as “high frequency current”), the high frequency current in only the second half of the cycle or the entire cycle having a peak current value that is higher than a current value of the first low frequency current; and a step (TS) of applying only a rectangular wave current at a second frequency (hereinafter, referred to as “second low frequency current”). The step (TL) and the step (TS) are repeated.

Here, a unit cycle UL in the time period TL or the step (TL) has a cyclic frequency within a range 70 Hz to 200 Hz, both inclusive, where the unit cycle UL is defined as {a half cycle of positive low frequency current, one cycle of high frequency current, a half cycle of negative low frequency current, and one cycle of high frequency current}.

In addition, the low frequency current in the time period TS or the step (TS) has a frequency within a range of 50 Hz to 100 Hz, both inclusive.

Further, a ratio of the duration of the time period TS or the step (TS) with respect to a total of the duration of the time period TL and the duration of the time period TS or the step (TS) is set within a range of 10% to 50%, both inclusive.

### BRIEF DESCRIPTION OF THE DRAWINGS

FIG. 1 is a circuit diagram of a conventional high pressure discharge lamp ballast.

FIG. 2 shows a lamp current waveform of the conventional high pressure discharge lamp ballast.

FIG. 3 shows a lamp current waveform of the present invention.

FIG. 4 is a diagram showing a configuration of a high pressure discharge lamp.

FIG. 5A shows of electrode projection shapes in a conventional driving method.

FIG. 5B shows electrode projection shapes in a driving method of the present invention.

FIG. 5C is a diagram for illustrating a state of an electrode projection.

FIG. 6A shows a change in the electrode projection shape in the driving method of the present invention.

FIG. 6B shows a change in the electrode projection shape in the driving method of the present invention.

FIG. 6C shows a change in the electrode projection shape in the driving method of the present invention.

FIG. 7 shows a lamp current waveform in an example of the present invention.

FIG. 8A shows lamp voltage variations in the case of using the conventional lamp current waveform.

FIG. 8B shows lamp voltage variations in the case of using the lamp current waveform of the present invention.

FIG. 9 shows a light source device of the present invention.

### DESCRIPTION OF THE EMBODIMENTS

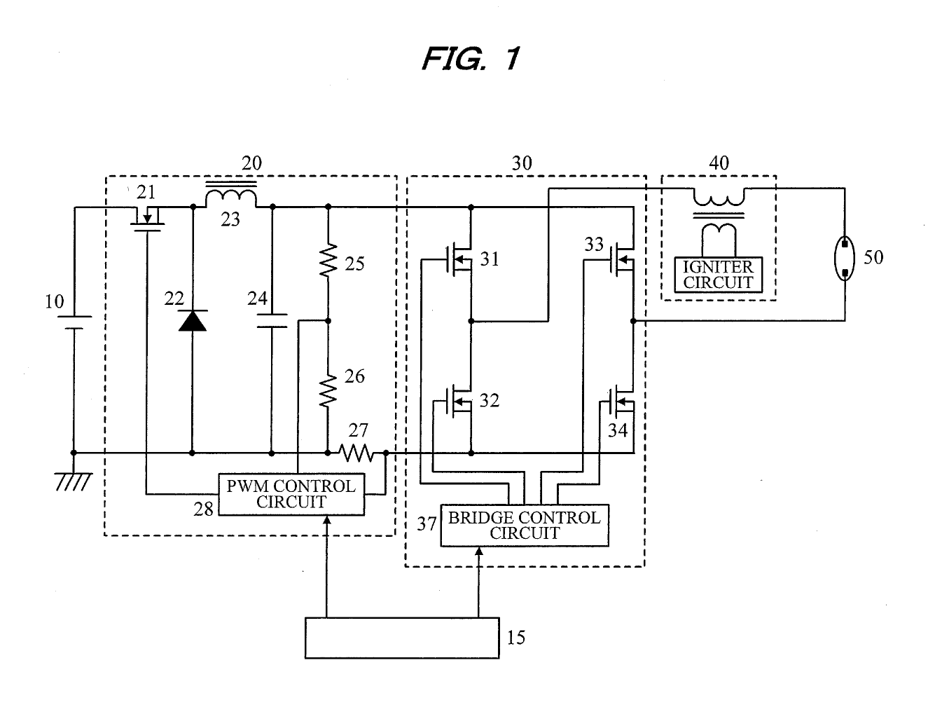

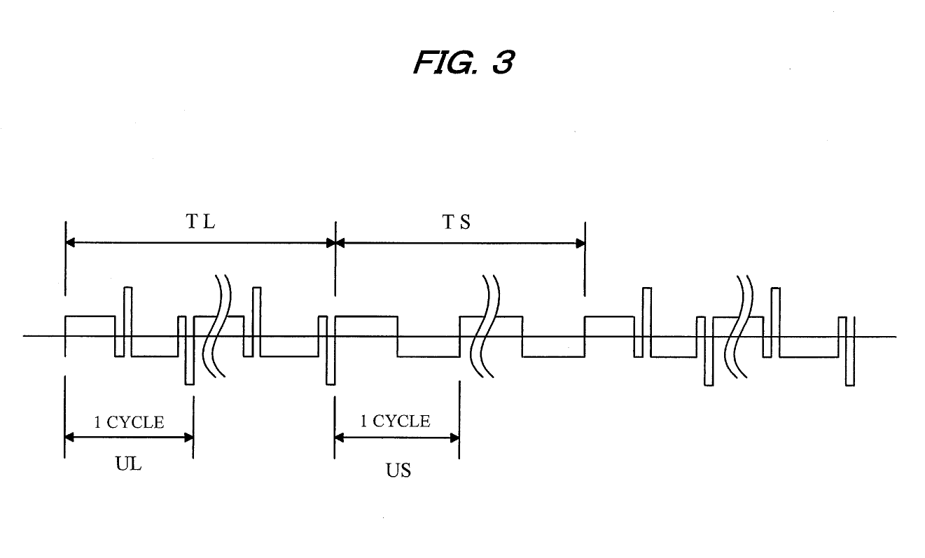

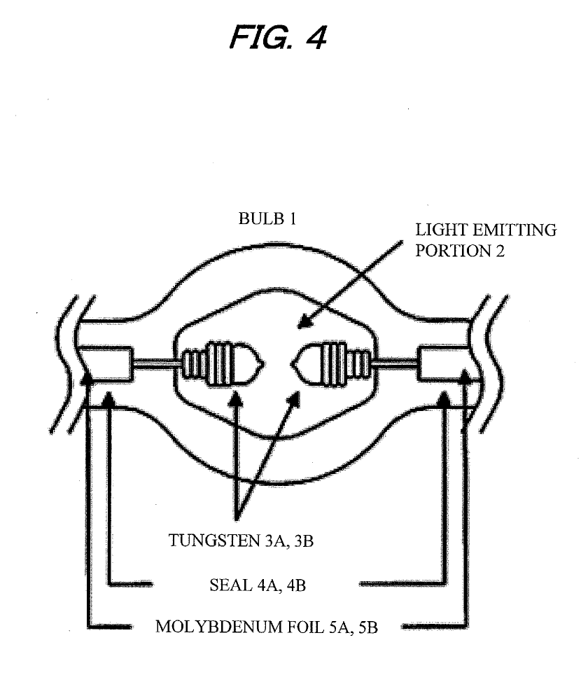

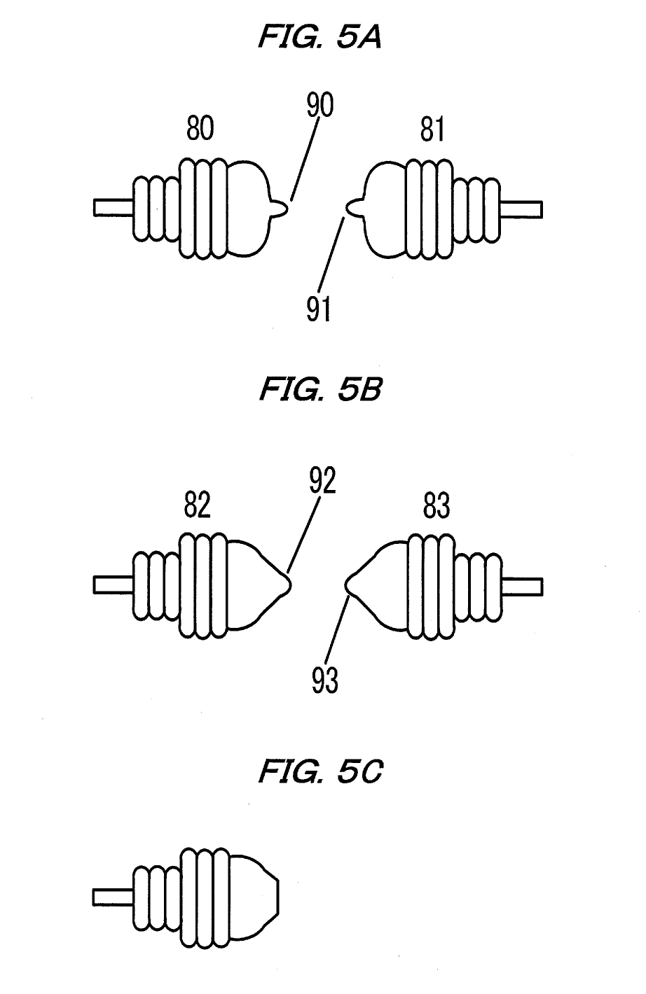

Description is provided below for embodiments of the present invention. Since the embodiments have the same circuit arrangement as that shown in FIG. 1, the description for the arrangement and operation thereof is omitted herein. In a lamp current wave of the present invention, a time period TL (step (TL)) and a time period TS (step (TS)) are alternately repeated as shown in FIG. 3. In the time period TL, a thin and small protrusion grows on each electrode as is the case with the conventional lamp. In the time period TS, the projection is melted. The repetition of these two steps brings about the formation of a projection in an approximately cone shape with a large diameter as shown by reference numerals 92 and 93 in FIG. 5B. The following description shows a formation process of the projection.

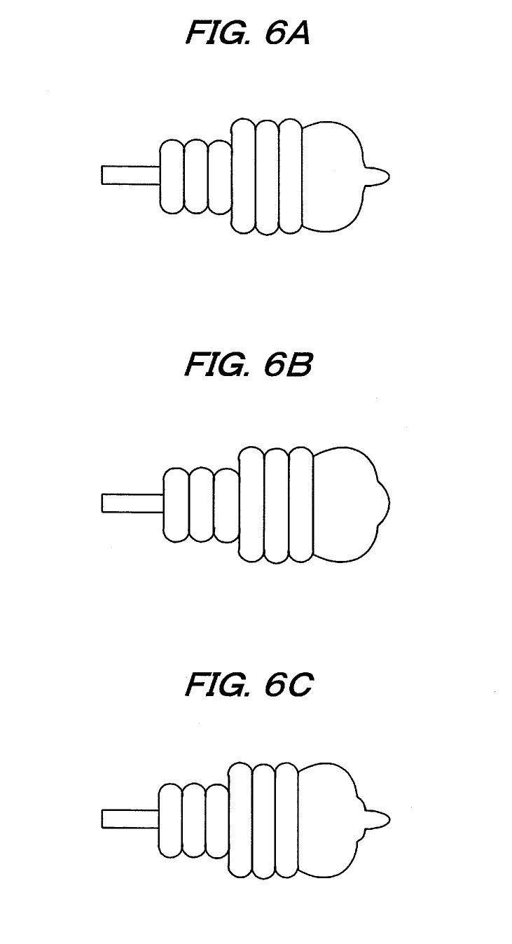

Firstly, in the time period TL, a thin and small projection grows as shown in FIG. 6A. Then, in the time period Ts, the projection is melted, and the tip end of the electrode is formed into a mountain shape with a vertex located at a position where the projection is present (FIG. 6B). In this state, since the projections are still present even having a gently-sloping mountain shape, the arc is kept discharged from the projections as the arc spots, and thereby no flicker occurs. In the next time period TL, a new thin and small projection again grows on the vertex of the mountain-shaped projection that has a high temperature by serving as the arc spot (FIG. 6C). Thus, a projection in an approximately cone shape with a large diameter is formed through the repetition of the above operations.

It should be noted that the frequencies in the time period TL and the time period TS need to be within appropriate ranges, respectively. When the frequencies are beyond the ranges, there occur problems, for example, that the projection in an approximately cone shape described above cannot be formed anymore, that flicker occurs, and that the polarity inversion becomes viewable. These appropriate ranges will be described later.

In addition, the time ratio of the time period TL to the time period TS is also important to form a projection in an approximately cone shape. When the time ratio of the time period TL is set too high (or the time ratio of the time period TS is set too low), a thin projection grows too long because the thin projection having grown in the time period TL cannot be melted to an appropriate extent in the time period Ts. In contrast, when the time ratio of the time period TL is set too low (or the time ratio of the time period TS is set too high), the tip end of the electrode is turned into a state shown in FIG. 5C because the thin projection is completely melted in the time period TS even though the projection has grown.

### EXAMPLE

A life test of a lamp was conducted by use of the waveform of the present invention. Here, the circuit configuration for the lamp is the same as that in FIG. 1.

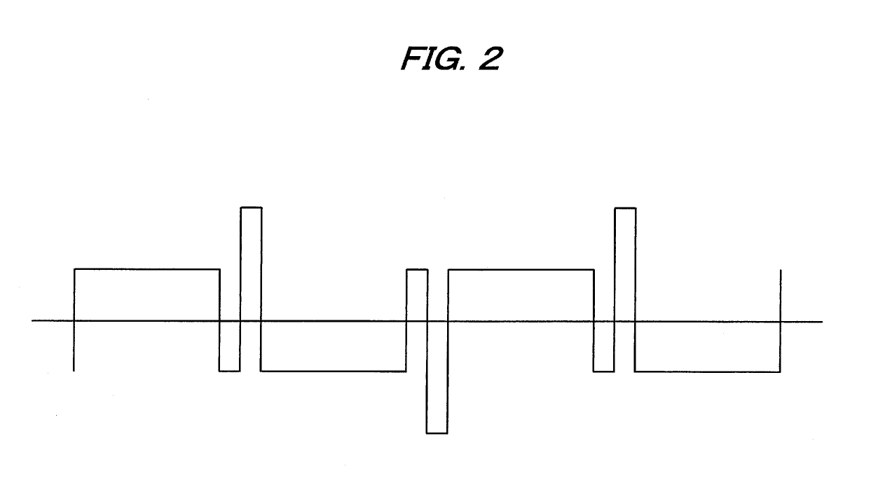

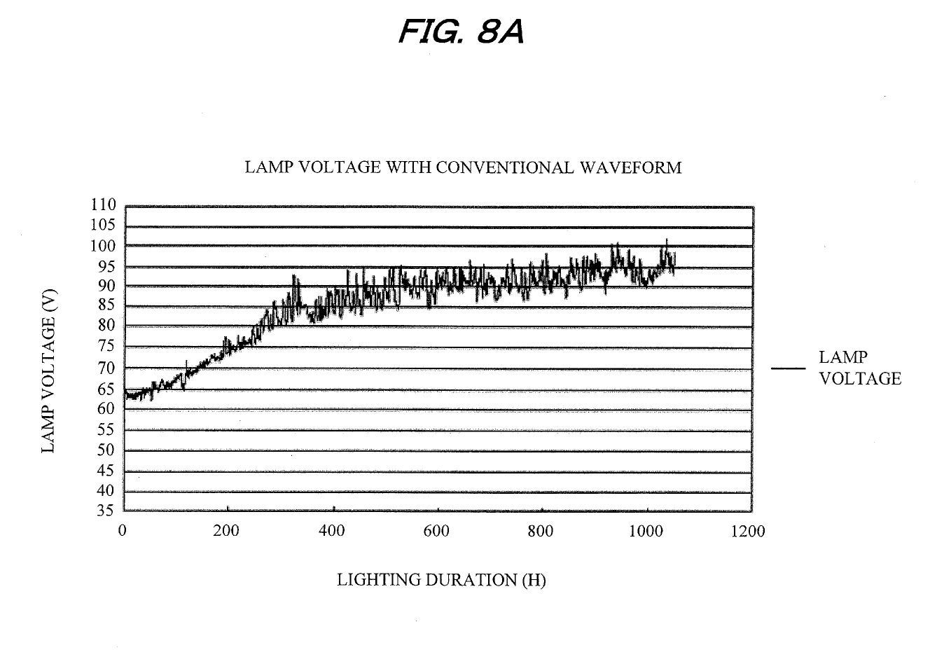

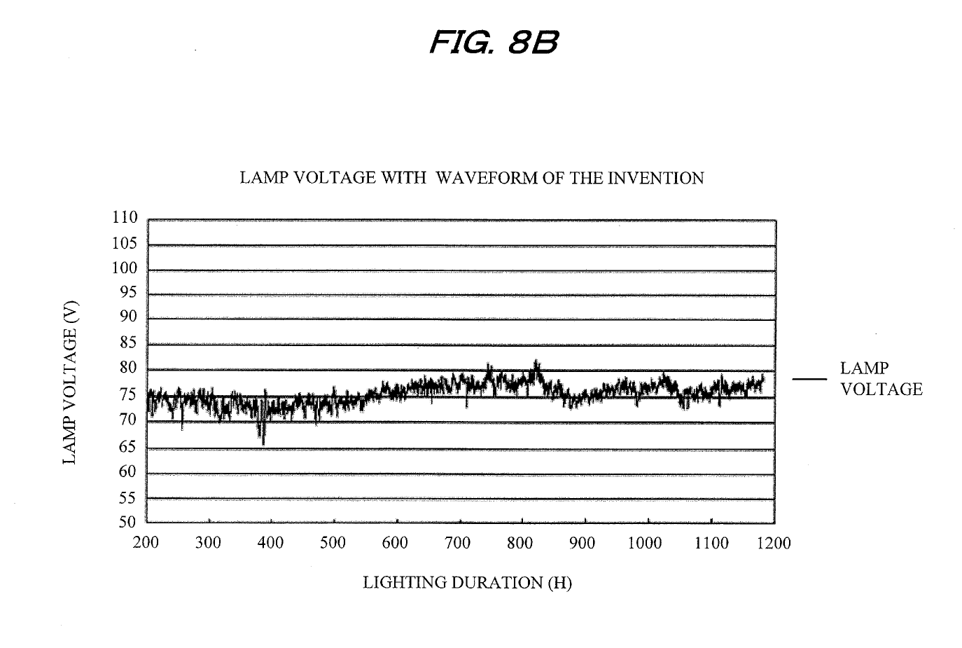

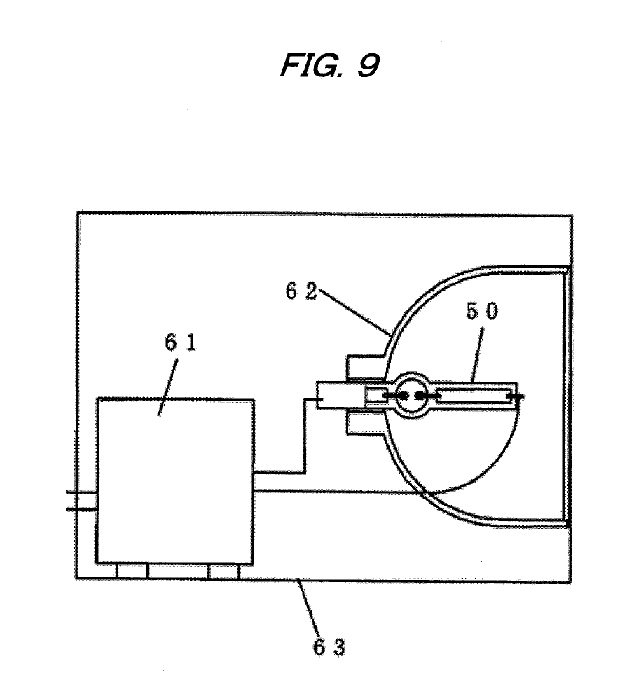

FIG. 8A shows variations of the lamp voltage for about 1000 hours in the life test using a conventional waveform. The conventional waveform herein is the waveform in FIG. 2 which was set at a frequency of 100 Hz; and set at a ratio of the duration of one cycle of the high frequency period to the duration of half cycle of the low frequency period of 1:6. Here, the peak current value in the second half cycle of the high frequency period was set at 1.1 to 1.5 times higher than the current value of the low frequency period (was changed within this range according to the lamp voltage).

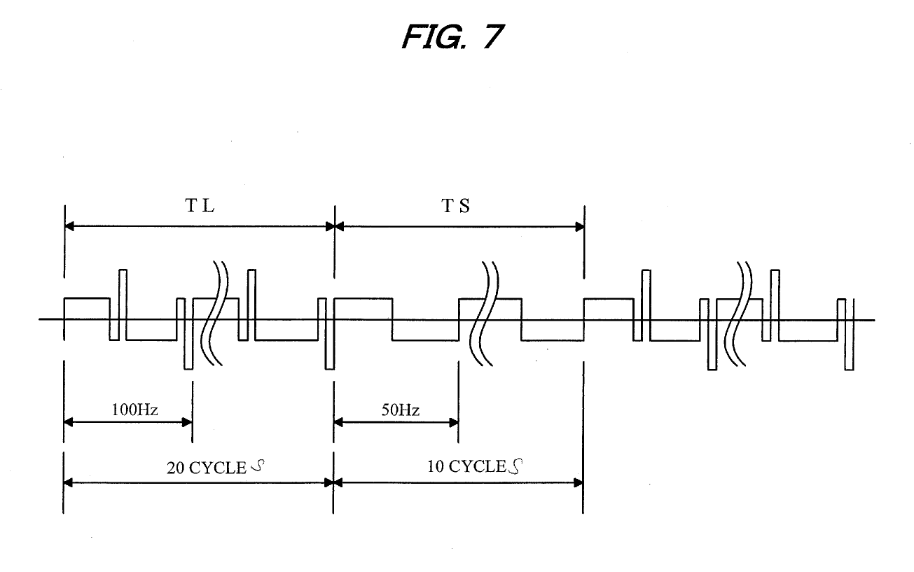

FIG. 8B shows variations of the lamp voltage for about 1000 hours in the life test using the waveform of the present invention. Here, the waveform of the present invention was set as shown in FIG. 7. Specifically, the time period TL was set to have unit cycles UL of {a half cycle of positive low frequency current, one cycle of high frequency current, a half cycle of negative low frequency current, and one cycle of high frequency current}, the cyclic frequency of the unit cycles UL was set at 100 Hz, and the number of cycles was set at 20 cycles. For the time period TS, the frequency of the unit cycles US was set at 50 Hz, and the number of cycles was set at 10 cycles.

In FIG. 8A of the conventional example, the lamp voltage increases to a great degree (in other words, the distance between the lamp electrodes increased due to the wearing of the electrodes). In contrast, in FIG. 8B of the present invention, the lamp voltage varies only at a very small degree, in other words, the projections were worn only to a small extent thereby to extend the life of the lamp, and thus a favorable result was obtained.

Description is provided below for findings about the waveform in each time period of the present invention. When the cyclic frequency of the unit cycles UL is less than 70 Hz, the electrode is formed into a stump shape as shown in FIG. 5C, flicker is more likely to occur due to a movement of the arc spot. In contrast, when the cyclic frequency of the unit cycles UL is more than 200 Hz, the lamp voltage increases. Hence, a preferable cyclic frequency of the unit cycles UL is within a range of 70 Hz to 200 Hz, both inclusive.

It has been known that, when the frequency in the time period TS is less than 50 Hz, the lamp has viewable polarity inversions and therefore is inappropriate as a light source device. In contrast, when the frequency in the time period TS is more than 100 Hz, the lamp voltage increases. Hence, a preferable frequency in the time period TS is within a range of 50 Hz to 100 Hz, both inclusive.

In terms of the time durations of the time period TL and the time period TS, when a ratio TS/ (TL+TS) is less than 10%, the waveform is similar to the conventional waveform shown in FIG. 2, and the effects of the present invention cannot be obtained. When the ratio TS/ (TL+TS) is more than 50%, the effect of the rectangular waveform (i.e., the effect of dissolving the electrode) is too large, and the electrode is turned into the same state as in FIG. 5c described above. Accordingly, a preferable ratio TS/ (TL+TS) is within a range of 10% to 50%, both inclusive. Here, the ratio TS/ (TL+TS) is set at 50% in the above example.

The above embodiment shows the high pressure discharge lamp ballast having the same configuration as the conventional high pressure discharge lamp, but being capable of forming thick projections, which are difficult to wear, on the electrodes in order to prevent flicker and a movement of the arc, and also to maintain the appropriate lamp voltage. FIG. 9 shows a projector as an application example using the high pressure discharge lamp ballast. In FIG. 9, reference numeral 61 denotes the high pressure discharge lamp ballast of the foregoing embodiment, 62 denotes a reflector to which the high pressure discharge lamp 50 is attached, 63 denotes a casing in which the high pressure discharge lamp ballast 61, the high pressure discharge lamp 50 and the reflector 62 are housed. FIG. 9 schematically shows the application example, and the actual dimensions, layout and the like thereof are different from those shown in FIG. 9. In addition, unillustrated components for an imaging system are arranged as needed in the casing 63 to form the projector.

In this way, a highly reliable and long-life projector having neither flicker nor an arc movement can be obtained.

According to the present invention, a projection in an approximately cone shape with a large diameter as shown in FIG. 5B can be formed. The present invention also prevents the projection from moving and allows for forming the projection that is difficult to wear.

What is claimed is:

1. A high pressure discharge lamp ballast, comprising:
power supply means for supplying an AC current to a high pressure discharge lamp; and
control means for cyclically changing a current value of the AC current to be supplied by the power supply means and a time interval between polarity inversions, wherein
the AC current has a cycle of a time period TL and a time period TS, and
the power supply means is controlled by the control means to apply a half cycle of a rectangular wave current at a first frequency (hereinafter, referred to as “first low frequency current”) and, immediately after that, apply one cycle of a current at a higher frequency than the first frequency (hereinafter, referred to as “high frequency current”) in the time period TL, the high frequency current in only the second half of the cycle or the entire cycle having a peak current value that is higher than a current value of the first low frequency current, and to repeat cycles of only a rectangular wave current at a second frequency (hereinafter, referred to as “second low frequency current”) in the time period TS.

2. The high pressure discharge lamp ballast according to claim 1, wherein
acyclic frequency of unit cycles UL in the time period TL is within a range of 70 Hz to 200 Hz, where the unit cycle UL is defined as {a half cycle of the first low frequency on a positive side, one cycle of the high frequency current, a half cycle of the first low frequency current on a negative side, and one cycle of the high frequency current}.

3. The high pressure discharge lamp ballast according to claim 1, wherein
the second low frequency current in the time period TS has a frequency within a range of 50 Hz to 100 Hz.

4. The high pressure discharge lamp ballast according to claim 1, wherein
a ratio of the duration of the time period TS with respect to a total of the duration of the time period TL and the duration of the time period TS is within a range of 10% to 50%.

5. A projector comprising:
the high pressure discharge lamp ballast according to claim 1;
a high pressure discharge lamp;
a reflector to which the high pressure discharge lamp is attached; and
a casing in which the high pressure discharge lamp ballast and the reflector are housed.

6. A method for driving a high pressure discharge lamp by using power supply means for supplying an AC current to a high pressure discharge lamp; and control means for cyclically changing a current value of the AC current to be supplied by the power supply means and a time interval between polarity inversions, the method comprising:
a step (TL) of applying a half cycle of a rectangular wave current at a first frequency (hereinafter, referred to as “first low frequency current”) and, immediately after that, applying one cycle of a current at a higher frequency than the first frequency (hereinafter, referred to as “high frequency current”), the high frequency current in only the second half of the cycle or the entire cycle having a peak current value that is higher than a current value of the first low frequency current; and
a step (TS) of applying only a rectangular wave current at a second frequency (hereinafter, referred to as “second low frequency current”), wherein
the step (TL) and the step (TS) are repeated.

7. The method according to claim 6, wherein
a cyclic frequency of unit cycles UL in the step (TL) is within a range of 70 Hz to 200 Hz, where the unit cycle UL is defined as {a half cycle of the first low frequency on a positive side, one cycle of the high frequency current, a half cycle of the first low frequency current on a negative side, and one cycle of the high frequency current}.

8. The method according to claim 6, wherein the second low frequency current in the step (TS) has a frequency within a range of 50 Hz to 100 Hz.

9. The method according to claim 6, wherein
a ratio of the duration of the step (TS) with respect to a total of the duration of the step (TL) and the duration of the step (TS) is within a range of 10% to 50%.
